(19) United States
(12) Patent Application Publication
(10) Pub. No.: US 2010/0193722 A1
(43) Pub. Date: Aug. 5, 2010

(54) Retractable Seal Ball Valve

(76) Inventor: Gary Jervis, Osgodby (GB)

Correspondence Address: FROST BROWN TODD, LLC, 2200 PNC CENTER, 201 E. FIFTH STREET, CINCINNATI, OH, 45202, US

(21) Appl. No.: 12/693,886

(22) Filed: Jan. 26, 2010

Related U.S. Application Data
(60) Provisional application No. 61/147,330, filed on Jan. 26, 2009.

(51) Int. Cl. F16K 5/06; B08B 3/00

(52) U.S. Cl. 251/315.1; 137/15.06

(57) ABSTRACT

Provided is a ball valve having a retractable main ball seal and a clean-in-place spindle seal. By moving opening the spindle seal, the spindle seal cavity may be cleaned without disassembly by allowing fluid flow around and within the ball valve cavity. Similarly, by retracting the main ball seal, the valve cavity may be cleaning without disassembly. Opening a spindle seal may allow the fluid to drain naturally. In addition, a method for cleaning such a ball valve is provided.

### PRIORITY

This application claims priority to and benefit of U.S. Provisional Application No. 61/147,330, filed on Jan. 26, 2009, which is herein incorporated by reference in its entirety.

### FIELD

Embodiments of the present invention relate, in general, to a ball valve, and, in particular, to a ball valve having a retractable main ball seal and a clean-in-place spindle seal allowing for cleaning within a pipeline.

### BACKGROUND

Ball valves may be difficult to clean effectively for a variety of reasons. The difficulty may arise due to the cavity between two main ball seals at either end of the valve. Such a cavity may tend to fill with product, which may then require water or other fluid to be flushed through the cavity through a separate cleaning solution inlet in the valve body. Even with an extra supply of cleaning solution there may be areas on the ball of the valve that may not be exposed to the flowing cleaning fluid. In addition, some valves may be difficult to clean due to their design. Some valve designs may include parts that fill the cavity between main ball seals to reduce the amount of contamination. Those designs, however, may not allow flowing cleaning fluid to contact all surfaces. Furthermore, the difficulty in cleaning some ball valves may stem from their assembly. Crevices or other small, but significant, gaps in which product can collect may be created during assembly, and such crevices may provide a good environment for bacterial growth or spore retention. Moreover, ball valves may be difficult to clean due to their spindle seal, where a spindle is a component of a ball valve allowing for rotation of the ball in the valve. Such a spindle may be sealed to stop the material flowing in the pipeline from leaking. A spindle seal may be difficult to clean as it may be located within the cavity between the two main ball seals in the ball valve and, thus, may not be exposed to a flowing cleaning fluid.

In some applications, a ball valve may have to be physically removed from the pipeline in order to be cleaned. For example, high hygiene applications may require that a valve be cleaned manually instead of automatically in the line. The removal of a valve for cleaning may present several issues. For one, removing a piece of equipment from the line may create a potential hazard to employee safety. In addition, cleaning a valve may be labor-intensive, time-consuming, and difficult to validate as part of a cleaning regime. Moreover, frequent disassembly of a valve may increase the probability of human error in valve reassembly.

Thus, it may be advantageous to retract a main ball seal from a ball, allowing cleaning solution to contact all surfaces of a ball valve cavity. It may also be advantageous to have cleaning fluid flow past a spindle seal and wash a spindle seal cavity to provide a buffer region from any areas which would otherwise be considered low hygiene due to an inability to clean these areas. In this way, a ball valve may be cleaned whilst still in the line, as part of an automated cleaning regime, which may be an automated pigging system hygienic application. As a result, employee safety and manufacturing efficiency may be improved, and the human error in valve assembly may be reduced. In addition, the ability to clean a ball valve in the line may permit a cleaning regime that is automatic and repeatable, which may then be validated.

### BRIEF DESCRIPTION OF THE DRAWINGS

The accompanying drawings incorporated in and forming a part of the specification illustrate several aspects of the present invention, and together with the description serve to explain the principles of the invention; it being understood, however, that the described embodiments are not limited to the precise arrangements shown. In the drawings, like reference numerals refer to like elements in the several views. In the drawings:

FIG. 1 is a perspective view of an exemplary ball valve.

FIG. 2 is a cross-sectional view of the ball valve from FIG. 1 along plane A.

FIG. 3A is an exploded view of an exemplary spindle seal actuator.

FIG. 3B is a cross-sectional view of the spindle seal actuator from FIG. 3A along line D-D′.

FIG. 4 is a cross section of an exemplary spindle seal actuator.

FIG. 5 is a cross section of an exemplary spindle seal actuator.

FIG. 6 is a cross-sectional view of the ball valve from FIG. 1 along plane B.

FIG. 7 is a cross-sectional view of the ball valve from FIG. 1 along plane C.

FIG. 8A is an exploded view of an exemplary main ball seal actuator.

FIG. 8B is a cross-sectional view of the main ball seal actuator from FIG. 8A along line E-E′.

FIG. 9 is a cross section of an exemplary main ball seal actuator.

FIG. 10 is a cross section of an exemplary main ball seal actuator.

### DETAILED DESCRIPTION

Versions of the present invention comprise a ball valve device that may be cleaned within a pipeline. Such a ball valve device may be cleaned at the same time the pipeline to which it is attached is cleaned. One embodiment involves a spindle seal, which is a seal that contacts the circumference of a spindle or axle that allows a ball in a ball valve to turn. A spindle seal may create a barrier to fluid while still allowing for rotation of the spindle. In this embodiment, the opening of a spindle seal may permit cleaning fluid flowing around a ball cavity to be redirected to contact a spindle seal surface and carry residual material to drain. In another embodiment, a ball valve having a retractable main seal may allow for cleaning of the valve within a line, which may include process pipe work. A main seal that may be retracted from the surface of a ball within a ball valve may allow for the flow of fluid around the complete surface of the ball and the cavity in which the ball is fixed. Such a retractable main seal may also allow for the use of pigging systems, which may require full bore ball valves, in high hygiene applications.

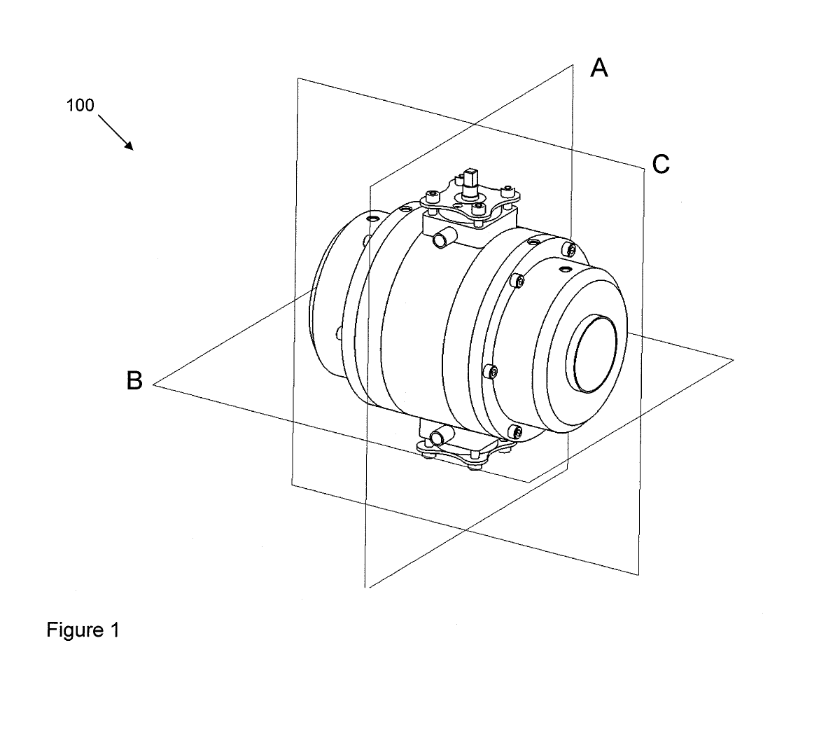

Referring to FIG. 1, a ball valve 100 is shown. Such a ball valve 100 may comprise a number of components. For example, ball valve 100 may comprise: a casing, a ball, a spindle or axle, a main ball seal, and a spindle or axle seal. A casing, in turn, may comprise a number of parts, which, when assembled, creates an internal cavity within which a ball is enclosed. In addition, a casing may join with two or more sections of a pipeline such that a product flowing through the line may reach the ball surface.

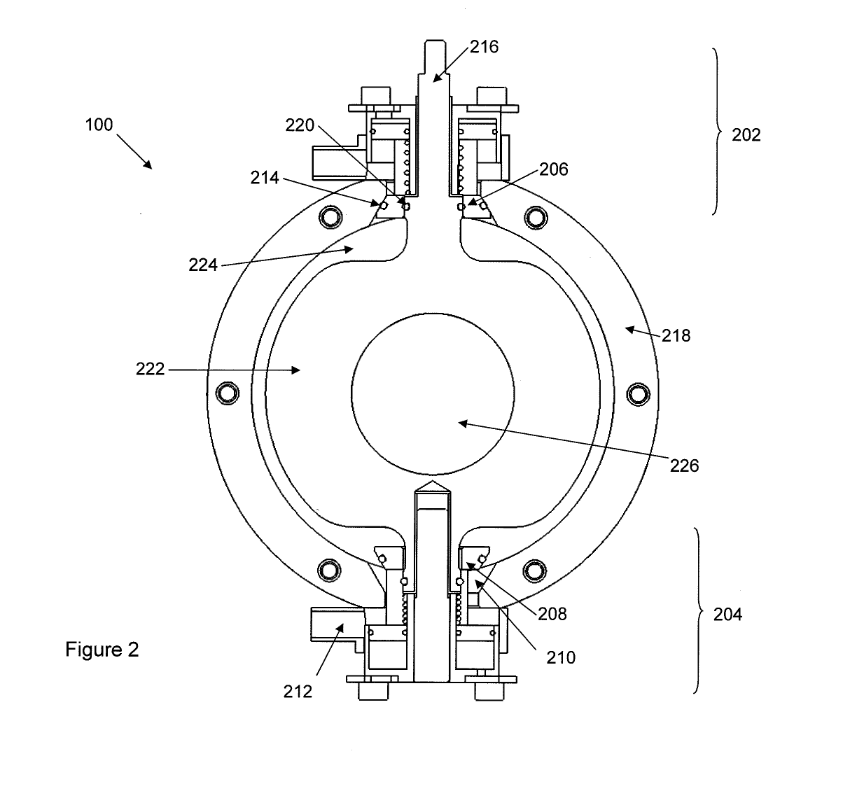

Referring to FIG. 2, a cross-section of a ball valve 100 is shown. A ball 222 located within a ball valve cavity 224 may be a sphere with a hole or holes 226 machined through it. When a hole 226 is aligned with the pipeline, product flowing through the pipeline may pass through the ball hole 226. Alternatively, when a hole 226 is not aligned with the pipeline, the ball 222 may obstruct the flow of the product. The ball 222 may be made of any suitable material as will be apparent to one of ordinary skill in the art. For example, in hygienic applications, a ball 222 may be made of 304L or 316L stainless steel. In addition, the ball 222 may solid and provide a single surface (i.e., no crevices or joints or seals) within a ball valve 100 such that so long as the ball is polished, it may provide a surface that is easily cleaned. The ball 222 may be removable from the ball carriage.

Ball valve 100 may include a spindle or axle 216 (hereinafter referred to collectively as “spindle”). A spindle 216 may be part of a machined ball 222, or it may be a separate part fitting into a keyway on ball 222, for example. A spindle 216 may allow an external turning force to rotate the ball 222, and thereby change the alignment of a ball hole 226. Ball valve 100 may also include a main ball seal (not pictured in FIG. 2), which may be in contact with the ball 222. When extended, a main seal may form a barrier to fluid flow when the ball 222 is not in alignment with the pipeline. Ball valve 100 may also comprise a spindle seal. A spindle seal may prevent product from leaking through a spindle cavity, which is the cavity in which a spindle rotates. Ball valve 100 may comprise other features or characteristics as will be apparent to one of ordinary skill in the art. For example, a ball valve 100 may have a minimal number of shoulders or crevices within a ball cavity, internal surfaces that may be cleaned without disassembly of the ball valve, a minimum amount of fluid collection in the ball cavity, the ability to be fully disassembled, and a cavity surrounding the ball that may allow near full rate of flow of the fluid supply.

In one embodiment, a spindle seal of a ball valve 100 may be opened, which may allow fluid to flow over a sealing surface and throughout the spindle cavity. The fluid may be a cleaning fluid. A number of cleaning fluids may be suitable to clean a ball valve 100 and/or pipeline as will be apparent to one of ordinary skill in the art. For example, hot water may be used as a cleaning fluid. In another example, the cleaning fluid may be a caustic solution or peraclean. The source of the cleaning fluid may be within a pipeline itself, such that no extra equipment or external source of cleaning fluid may be required. During cleaning, cleaning fluid may flow past the spindle seal surface and carry any residual material away to drain. The cleaning procedure may be automated, and if it is, it may also be validated and made repeatable. Whereas traditional ball valves, when mounted horizontally, may allow a small amount of liquid to sit in the bottom of a ball cavity even after cleaning or pigging the line, the spindle seal design described in this application, when mounted at the low point of a ball valve, may be used as a low point drain for fluid, even when the valve 100 is mounted horizontally.

Referring again to FIG. 2, ball valve 100 may include two spindle seal actuators: top spindle seal actuator 202 and bottom spindle seal actuator 204. A spindle seal actuator may hold a ball 222 in position. FIG. 2 shows spindle seal carriage 206 in a closed or sealing position and spindle seal carriage 208 in an open or clean-in-place position. The sealing position may be a default position for a spindle seal. The clean-in-place position may allow fluid remaining in valve cavity 224 to drain out through seal seat 210 and drain 212. A seal seat 210 may be a cavity into which a spindle seal carriage 206 or 208 may be pressed. Because spindle seal carriages 206 and 208 may be identical, the remainder of this application will refer only to carriage 206 unless a distinction is necessary. A spindle seal carriage 206 may be made out of any suitable material as will be apparent to one of ordinary skill in the art. For example, spindle seal carriage 206 may be made of stainless steel. A spindle seal may be created by any number of o-rings as will be apparent to one of ordinary skill in the art. For example, FIG. 2 shows two o-rings, 214 and 220, comprising a spindle seal. A first o-ring 214 may be mounted in seal carriage 206 and used to seal a spindle 216 from valve casing 218. A second o-ring 220 may be mounted in a ball valve spindle 216. Second o-ring 220 may provide a second sealing point. O-rings 214 and 220 may be open to contact with a cleaning fluid when in a clean-in-place position. Any crevices created by assembly of ball valve 100 may also be open to the flow of a cleaning fluid. Such crevices may be open to the flow of a cleaning fluid due to the retraction of a main ball seal from contact with a ball.

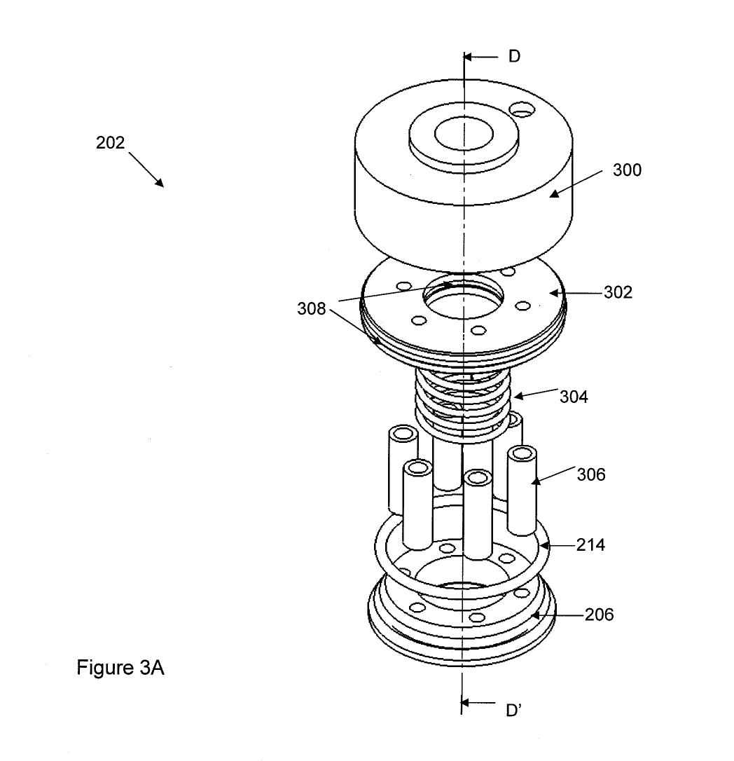

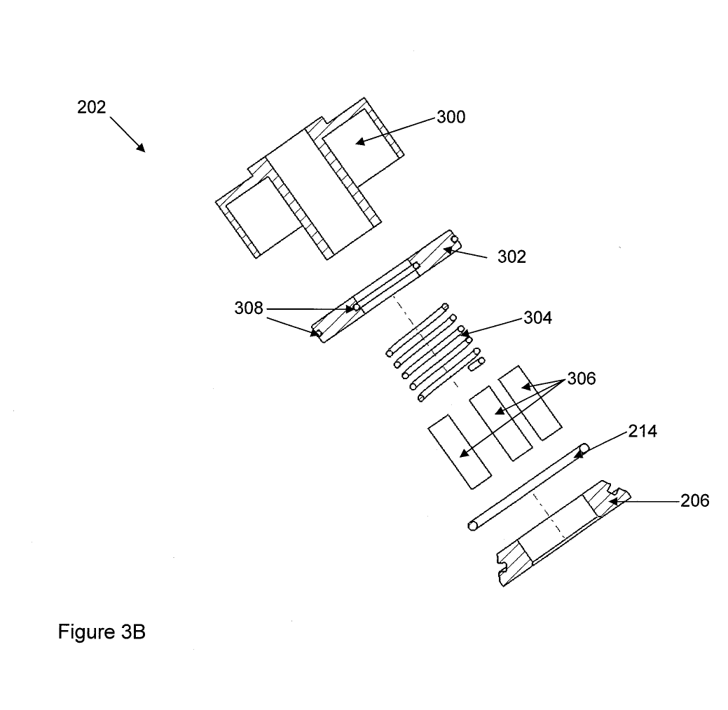

Referring to FIGS. 3A and 3B, components that may comprise top spindle seal actuator 202 are shown. Similar components (not pictured) may comprise a bottom spindle seal actuator 204. A spindle seal actuator 202 may comprise any number of components as will be apparent to those of ordinary skill in the art. For example, a spindle seal actuator 202 may comprise an actuator body 300, a piston 302 having piston o-rings 308 fitted, an actuator spring 304, a seal carriage support 306, a sealing o-ring 214, and a seal carriage 206.

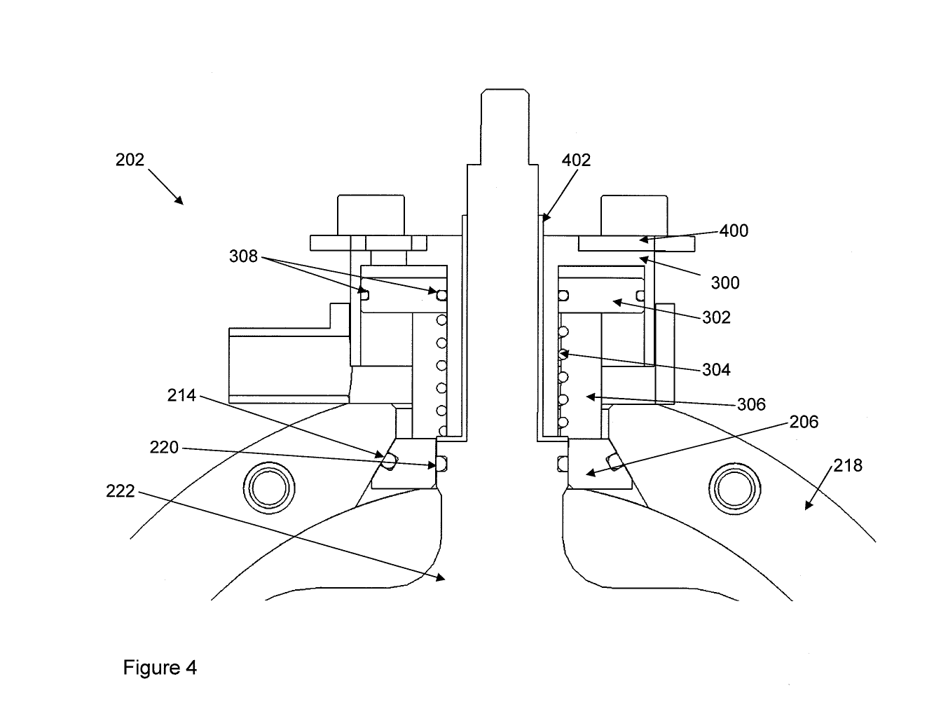

FIG. 4 shows another view of the components that may comprise a top spindle seal actuator 202. For example, a spindle seal actuator 202 may comprise a an outer casing 218, a ball 222, an end plate 400, an actuator body 300, a piston 302, an actuator spring 304, a spindle seal carriage support 306, a shaft bearing 402, sealing o-rings 214 and 220, and a spindle seal carriage 206. Spindle seal actuator 202 may be pneumatic with a return spring 304. Valve casing 218 may be part of ball valve 100 to which a spindle seal actuator 202 may be affixed. Actuator body 300 may be used to mount the shaft bearing 402, which may provide a low resistance to rotation on spindle 216, and therefore on ball 222. In combination with end plate 400, actuator body 300 may keep spindle 216, and therefore a ball 222, in position in the center of the hole through which the spindle 216 exits a valve 100. End plate 400 may be tightened, and as it is, the plate 400 may press down onto actuator body 300. Actuator body 300 may then press onto the shoulder of spindle 216. An actuator body of a bottom spindle seal actuator 204 (not pictured in FIG. 4) may do the same. In this way, ball 222 may be held in place vertically.

Seal piston 302 may be pressed into an actuator body 300. Piston o-rings 308 on the inner and outer edges of piston 302 may form a sealed cavity into which compressed gas may be supplied. Supplying compressed gas to the cavity may force piston 302 to exert force against spindle seal actuator spring 304. Full compression of spring 304 may prevent piston 302 from moving any farther into actuator body 300. When not compressed, spring 304 may also force seal piston 302, and therefore seal carriage 206, into a closed position without the use of compressed gas.

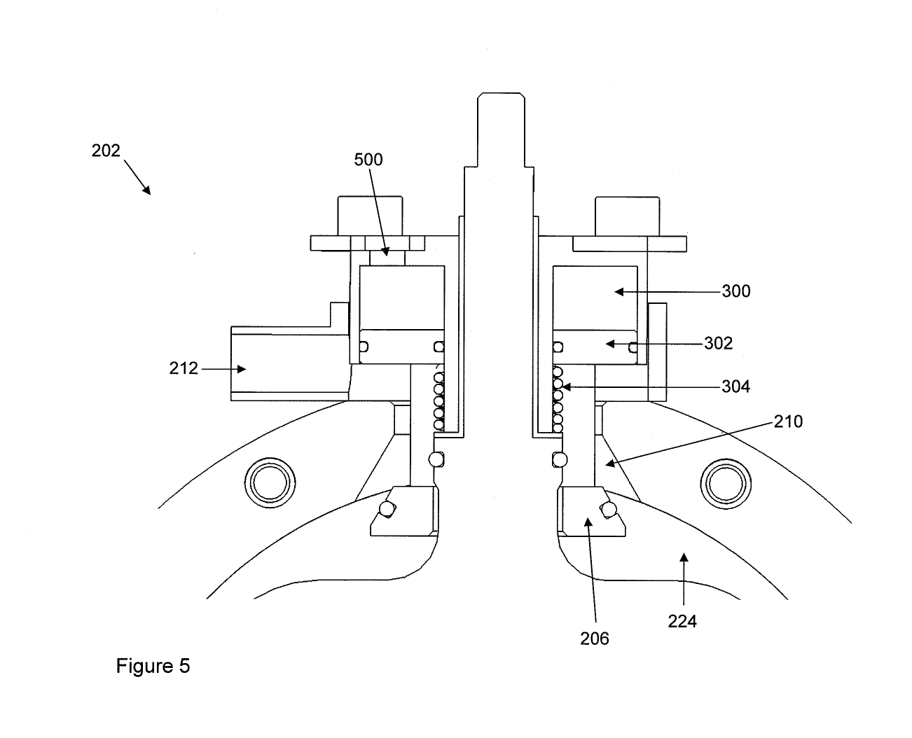

A spindle seal carriage support 306 may connect a seal carriage 206 and a piston 302. In this way, when a piston 302 moves as a result of a force exerted by compressed gas or a spring 304, a seal carriage 206 may also be moved from a seal seat 210. In addition, by contacting the shoulder of ball 222, carriage support 306 may help keep the ball 222 in alignment in a valve 100. A spindle seal carriage support 306 may be made of any suitable material as will be apparent to one of ordinary skill in the art. For example, a carriage support 306 may be made of ethylene propylene diene monomer (EPDM). Any number of carriage supports 306 may be included in ball valve 100. For example, FIG. 3 shows six carriage supports 306. Gaps that may exist between carriage supports 306 may permit the passage of fluid. The fluid may be a cleaning fluid.

Whereas FIG. 4 shows a top spindle seal actuator 202 in a sealing position, FIG. 5 shows a top spindle seal actuator 202 in a clean-in-place position. In a sealing position, a seal carriage 206 and first and second o-rings 214 and 220 may provide a spindle seal that inhibits the movement of a fluid between valve cavity 224 and a spindle seal surface. In a clean-in-place position, a piston 302, and therefore a seal carriage 206, may be displaced allowing a fluid to flow between a valve cavity 224 and a spindle seal surface.

To clean a ball valve 100 in place in a pipeline, a spindle seal actuator 202 may be supplied with compressed gas through an inlet port 500. An actuator 202 may be pneumatic. Compressed gas may enter actuator 202 through inlet port 500 and pressurize an enclosed area until the pressure is sufficient to overcome the force of a spring 304 pushing piston 302 into the actuator 202. The compressed gas may force a piston 302 to compress an actuator spring 304 fully, at which point the movement of piston 302 may be impeded. Any suitable gas may be used as will be apparent to one of ordinary skill in the art. For example, a compressed atmospheric gas, such as nitrogen or carbon dioxide, may be used. In addition, the gas may be kept under any suitable pressure as will be apparent to one of ordinary skill in the art. For example, a gas may be supplied on site at a pressure of 6-7 bar, while normal operating pressure may be 5.5-6.5 bar(g). Due to the movement of a piston 302 and the connection between a piston 302 and a seal carriage 206 via a seal carriage support 306, the seal carriage 206 may be pushed into a valve cavity 224. Pressurized cleaning fluid that may then be pumped through a valve cavity 224 may be diverted through the open area created by moving a seal carriage 206 away from a seal seat 210. The cleaning fluid may then flow past the surface of the seal carriage 206 and the seal seat 210 to an external drain 212. An internal spindle seal provided by second o-ring 220 may also be exposed to the cleaning fluid.

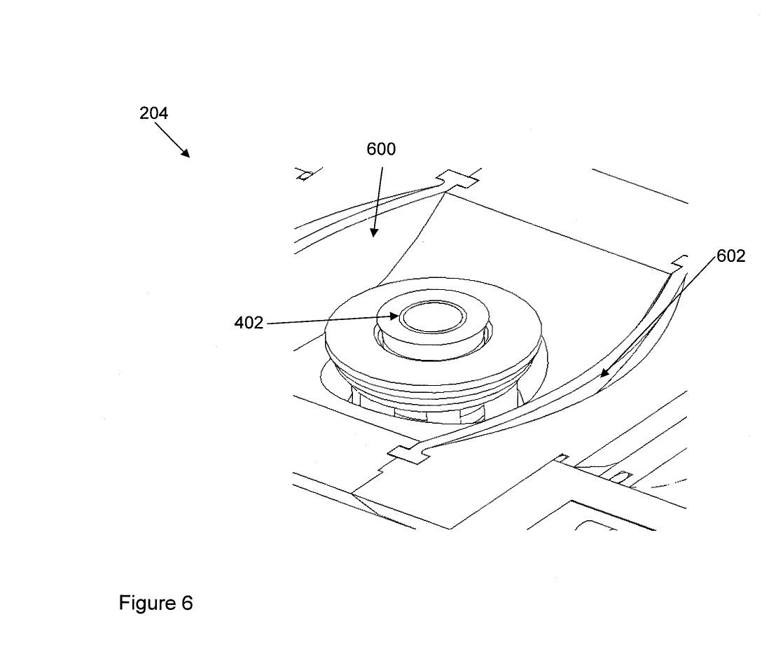

Referring to FIG. 6, a cross section of a bottom spindle seal actuator 204 is shown. Bottom actuator 204 is shown in FIG. 6 to be in a clean-in-place position in which seal carriage 208 is not pressing against seal seat 210. When in a clean-in-place position, residual fluid in a ball valve 100 may drain naturally according to gravity. Alternatively, a compressed gas may be used to expel residual fluid from a ball valve 100. Main ball seals 600 and 602 are also shown in FIG. 6.

FIGS. 2-6 display an embodiment of a spindle seal design, wherein fluid located in ball valve cavity 224 may be permitted or prohibited from flowing around a spindle seal surface and out to drain depending on the position of the spindle seal. If the seal is in a sealing position, fluid in valve cavity 224 may be prevented from flowing around a spindle seal surface. If, however, the seal is in a clean-in-place position, such fluid may be allowed to flow past and around a spindle seal and out to drain. As well as being used to purge a cleaning solution or other fluid from a ball valve 100, such a spindle seal design may be used to introduce a cleaning solution or other fluid into a ball valve cavity 224. A spindle seal design as shown in FIGS. 2-6 may also be used in combination with a main ball seal as will be apparent to one of ordinary skill in the art. For example, such a spindle seal design may be used in conjunction with an inflatable main ball seal. In another example, a main ball seal that uses a mechanical means, such as a rotatable thread, to form a ball seal may be used in combination with a spindle seal design.

In another embodiment, a diaphragm of a ball valve 100, which together with a ball 222 may comprise a main ball seal, may be retracted to allow fluid to travel around a ball cavity 224 instead of or in addition to through a central bore of a ball 222. The fluid may be, for example, a cleaning solution. A number of cleaning fluids may be suitable to clean a ball valve and/or pipeline as will be apparent to one of ordinary skill in the art. For example, hot water may be a cleaning fluid. In another example, the cleaning fluid may be a caustic solution or peraclean. The source of the cleaning fluid may be within a pipeline itself, such that no extra equipment or external source of cleaning fluid may be required. To clean a ball valve 100 in such a way, the valve 100 may be turned to a semi-closed position. In such a semi-closed position, fluid may not be permitted to flow through the ball 222 and instead must travel into the valve cavity 224. To be in a semi-closed position, the central bore 226 in ball 222 may not be in alignment with the pipeline, and the main ball seals may not be in extension. Any cleaning solution or other fluid that may flow through a ball valve 100 may then be forced around the ball 222 and may contact all surfaces of a ball cavity 224. Alternatively, ball valve 100 may be cleaned while valve 100 is in an open position. In such an open position, fluid may be permitted to flow through ball 222 as well as into valve cavity 224. To be in an open position, the hole 226 in ball 222 may be in alignment with the surrounding pipeline. In addition, a main ball seal may be retracted such that fluid may flow between a pipeline and valve cavity 224. By contrast, if a ball valve 100 is in a completely closed position (i.e., hole 226 may not be in alignment with the pipeline and main ball seals may not be retracted) no fluid will be permitted to flow into or out of the valve 100. The cleaning procedure may be automated, and if it is, it may also be validated and made repeatable.

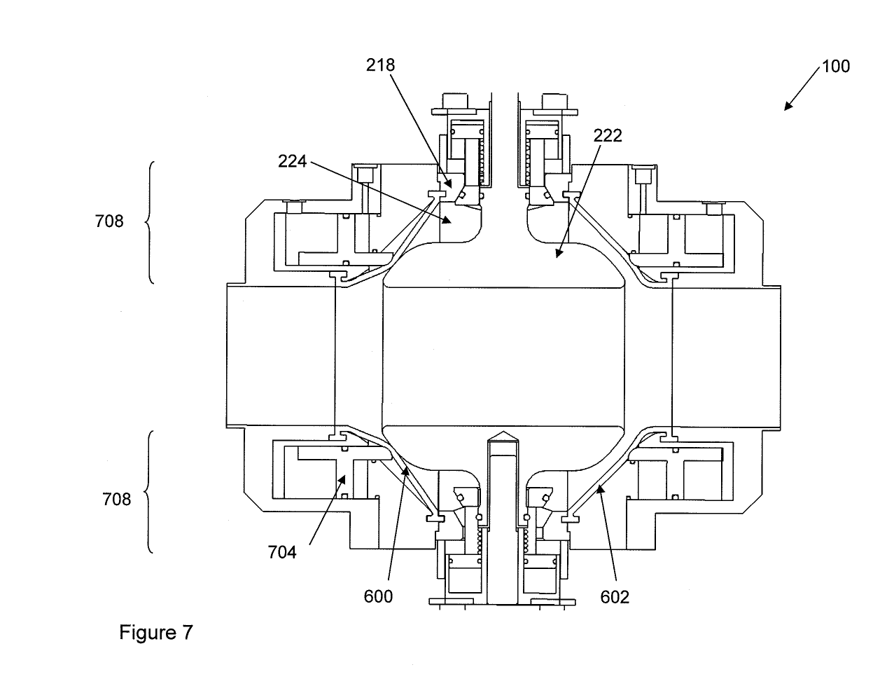

Referring to FIG. 7, a cross section of a ball valve 100 is shown with retractable diaphragms 600 and 602. As shown in FIG. 7, diaphragm 600 is in an extended position, and diaphragm 602 is in a retracted position. In FIG. 6, both diaphragms 600 and 602 are in a retracted position. Because diaphragms 600 and 602 may be identical, the remainder of application will refer only to diaphragm 600 unless a distinction is necessary. Returning to FIG. 7, a main ball seal may be formed by a seal piston 704 pushing a diaphragm 600 against a ball 222. A diaphragm 600 may be made out of any suitable material as will be apparent to one of ordinary skill in the art. For example, diaphragm 600 may be made of silicon rubber, ethylene propylene diene monomer rubber (EPDM), an Isolast® perfluoroelastomer, or other material having high resistance to chemical attack. Moreover, diaphragm 600 may be elastic such that it may be pressed against the surface of a ball 222 to create a main ball seal regardless of any imperfections or misalignments in valve assembly. In addition, a diaphragm 600 may have anti-bacterial properties, such that any remaining crevices created by the design and construction of a ball valve 100 may be in direct contact with a material that actively discourages bacteria or spore growth. Furthermore, the surface of a diaphragm 600 may be smooth. Having a smooth interior surface may reduce to a minimum the number of crevices that may trap bacteria or spores and permit the removal of contaminants by flushing with a cleaning fluid. Although FIG. 7 shows a diaphragm at either end of the valve 100, some applications may require a greater or fewer number of main ball seals. For instance, if ball valve 100 was a three-way or four-way ball valve, a greater number of main ball seals may be required. In another embodiment, a diaphragm 600 may be expanded to encompass a whole ball 222 and create a sealing surface for a spindle seal as well. In this way, the number of internal surface joints may be reduced. In yet another embodiment, a ball 222 may be made the rotor of a motor by using external electrical coils to generate a field that would rotate a ball 222 without need for spindles protruding to the outside of the valve. In this way, spindle seals may not be needed for the ball valve.

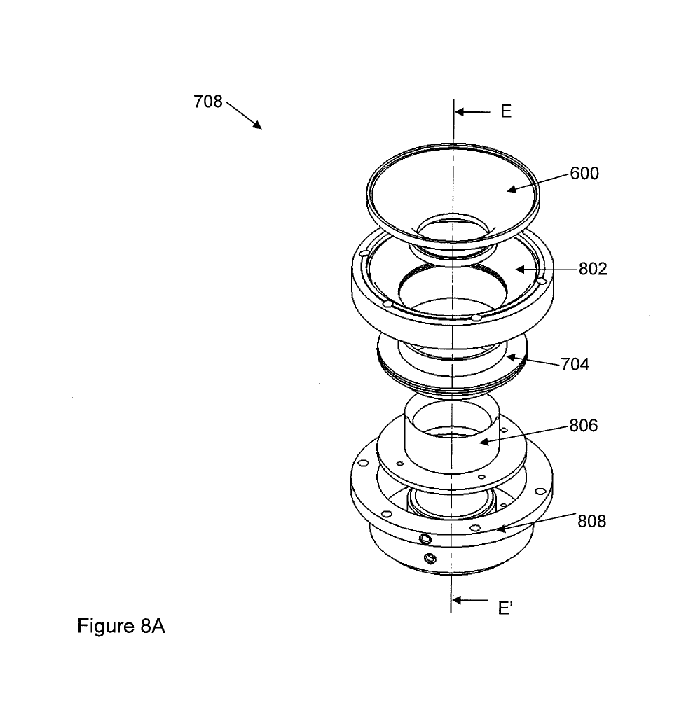

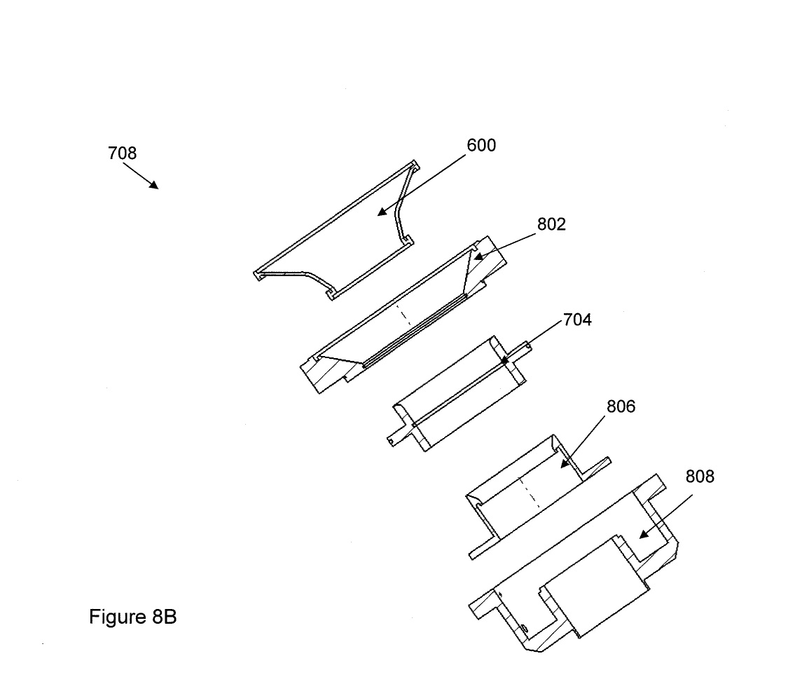

Referring to FIGS. 8A and 8B, components that may comprise a main seal actuator 708 are shown. A main seal actuator 708 may comprise any number of components as will be apparent to those of ordinary skill in the art. For example, a main seal actuator 708 may comprise a diaphragm 600, a seal flange 802, a piston 704, a seal clamp 806, and an actuator body 808. Seal flange 802 may form part of the main seal actuator 708 and hold one end of diaphragm 600 in place by clamping it to valve casing 218. In addition, actuator body 808 may be a cylinder in which piston 704 may be displaced by compressed gas. Actuator body 808 may also provide a “butt end” fitting to which a pipe may be welded or otherwise attached. Seal clamp 806 may clamp the other end of diaphragm 600 to the actuator body 808. Main seal actuator 708 may be pneumatic with an optional return spring (not pictured in FIGS. 8A-8B).

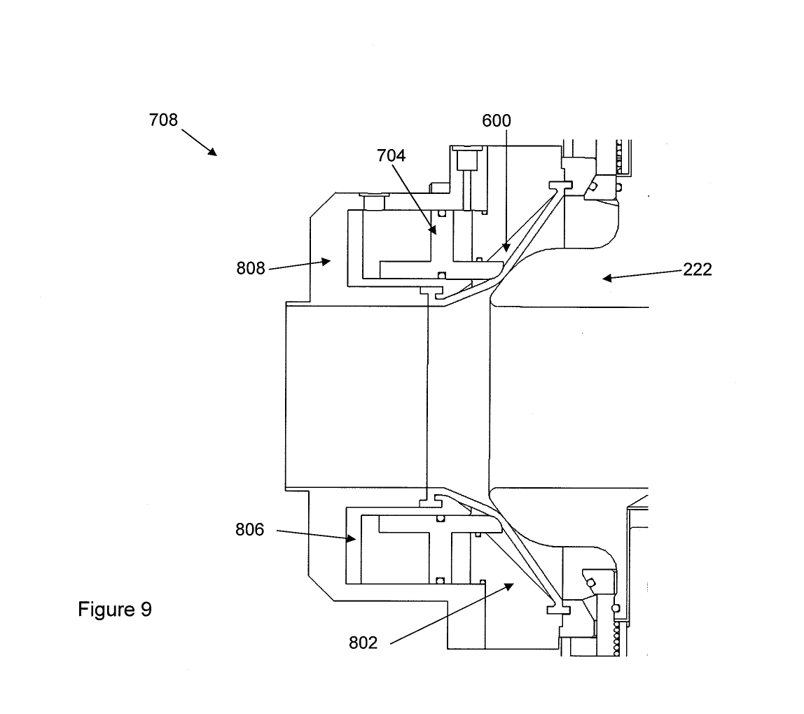

FIG. 9 shows another view of components that may comprise a main ball seal actuator 708. The seal arrangement as shown may require compressed gas to extend and/or retract a diaphragm 600. Alternatively, actuator 708 may be fitted with a plurality of springs providing a failsafe option wherein a diaphragm 600 may be extended without the use of compressed gas. For example, a spring (not pictured in FIG. 9) may be fitted in a main ball seal actuator 708 such that the default position of a seal piston 704 is in extension, and not retraction. In such an embodiment, the degree of sealing may be dependent upon the strength of the spring. Alternatively, compressed gas may be utilized in addition to or instead of a spring. For example, both compressed gas and a spring in a main ball seal actuator 708 may be used if the level of sealing created between a ball 222 and a diaphragm 600 using a spring alone is insufficient.

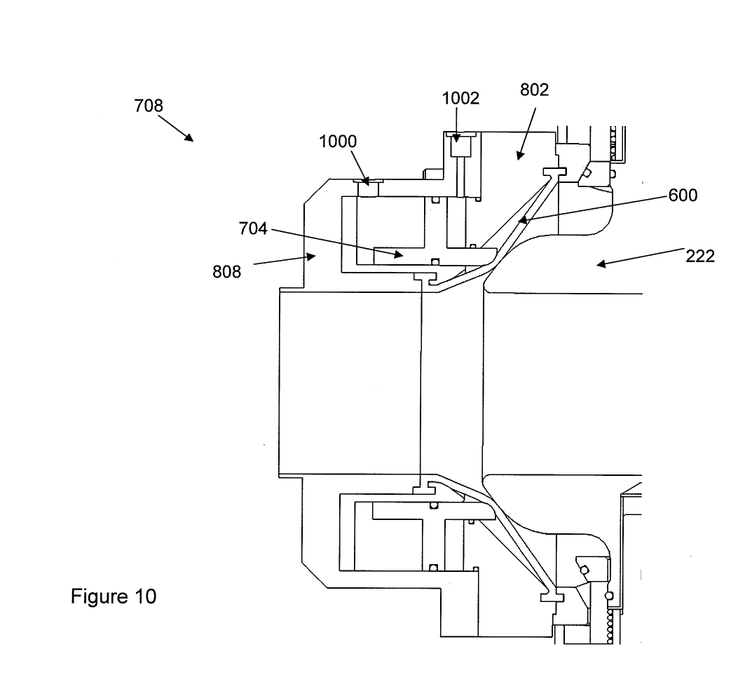

Referring to FIG. 10, another view of a main ball seal actuator 708 and diaphragm 600 is shown. To extend a diaphragm 600 and therefore make a main ball seal, a main ball seal actuator 708 may be supplied with compressed gas through a first port 1000. The compressed gas may be supplied at any suitable pressure as will be apparent to one of ordinary skill in the art. For example, a gas may be supplied on site at a pressure of 6-7 bar, while normal operating pressure may be 5.5-6.5 bar(g). Any suitable gas may be used as will be apparent to one of ordinary skill in the art. For example, a compressed atmospheric gas, such as nitrogen or carbon dioxide, may be used. The compressed gas may force a seal piston 704 towards ball 222. Displaced gas may exit through a second port 1002. Movement of a piston 704 may then force a diaphragm 600 against the ball 222 to form a main ball seal, which may cause any product or fluid flowing through a pipeline to pass through hole 226 in ball 222. Alternatively, if a hole in ball 222 is not in alignment with a pipeline such that the ball valve 100 could be described as being in a closed position, a main ball seal would form a complete barrier to the flow of any product or fluid in the pipeline. Diaphragm 600 itself may not pressurized and may be separated from an actuating force, such that there may be a lesser likelihood that the compressed gas could pressurize the line or contaminate the product.

To retract a diaphragm 600 and therefore open a main ball seal, compressed gas may enter an actuator body 808 via a second port 1002. The movement of the compressed gas through the second port 1002 may force a piston 704 away from a ball 222 thereby releasing a diaphragm 600 from the surface of ball 222. Displaced gas may exit through a first port 1000. If diaphragm 600 is elastic, it may return to its original shape. The retraction of a main ball seal in a such a way may permit a fluid, which may be a cleaning fluid, to contact all internal surfaces of a valve cavity 224. And if a spindle seal is in a clean-in-place position, such fluid in valve cavity 224 may be permitted to flow around the spindle seal as well.

In another embodiment, a ball valve 100 may be cleaned via a pigging system. In such a system, a pig may be used to force a product from a pipeline. Cleaning fluid may then be pumped through a pipeline port to clean the central bore 226 of a ball 222 and remove any product residue or other material. A ball seal diaphragm 600 may then be retracted and the ball 222 rotated to a closed position. In this way, the cleaning fluid may be forced around the surface of the ball 222 and throughout the ball cavity 224. A spindle seal actuator 202 may then be opened (i.e., in the clean-in-place position) to allow cleaning fluid to pass past the spindle seal to drain. If a bottom spindle seal actuator 204 is opened, cleaning fluid may drain naturally using gravity to force the fluid out. Alternatively, a pig may be used to force a cleaning fluid from a pipeline. The pipeline may then be drained using a spindle seal actuator to open a bottom spindle seal and allow a cleaning fluid to drain from a ball cavity.

In another embodiment, a ball valve may be used in a “block and bleed” configuration, which may protect a flowing product from contamination due to a seal failure. In such a configuration, a pipeline may be sealed in two places with a valve to drain located within the two seals. For example, a ball seal diaphragm may be in an extended position and a spindle seal may be in an open position to allow for a “block and bleed” configuration.

The versions presented in this disclosure are examples. Those skilled in the art can develop modifications and variants that do not depart from the spirit and scope of the disclosed ball valve. For example, the devices and cleaning systems described in this application may be used with a ball valve having more than two points of entry for an accompanying pipeline. For instance, a retractable seal design may be utilized in three-way and four-way valves, in addition to a simple open/close ball valve. Thus, the scope of the invention should be determined by appended claims and their legal equivalents, rather than by the examples given.

What is claimed is:

1. A ball valve device for use in a pipeline, the ball valve device comprising:
a. a body that defines a spindle cavity and an inner cavity, the inner cavity having a passageway through which a product can flow, wherein the body is configured for attachment to a pipeline;
b. a ball positioned within the inner cavity of the body, the ball having a central bore, wherein the ball is rotatable between a first position in which the central bore is in alignment with the passageway of the inner cavity such that flow of product through the bore is permitted and a second position in which the central bore is not aligned with the passageway of the inner cavity such that flow of product through the bore is obstructed;
c. a rotatable spindle positioned within the spindle cavity, the rotatable spindle being coupled with the ball such that rotation of the spindle causes a corresponding rotation of the ball;
d. at least one seal positioned within the body, the at least one seal being moveable between an open position and a closed position; and
e. a drain extending from the body, the drain permitting the product to flow out of the ball valve device.

2. The ball valve device of claim 1, wherein the at least one seal is a spindle seal positioned within the spindle cavity, wherein the spindle seal contacts the spindle when the spindle seal is in the closed position to obstruct the flow of product into or out of the spindle cavity.

3. The ball valve device of claim 2 further comprising at least one piston, wherein movement of the piston causes the spindle seal to move between the open position and the closed position.

4. The ball valve device of claim 3, wherein the piston is pneumatic.

5. The ball valve device of claim 4, wherein the piston is moveable by a force exerted by a mechanism selected from the group consisting of compressed gas and an actuator spring.

6. The ball valve device of claim 2, wherein the spindle seal comprises at least one o-ring.

7. The ball valve device of claim 1, wherein the at least one seal is a main ball seal positioned within the inner cavity of the body, wherein the main ball seal contacts a surface of the ball when the main ball seal is in the closed position to obstruct the flow of product into or out of the inner cavity.

8. The ball valve device of claim 7, wherein the main ball seal is inflatable.

9. The ball valve device of claim 7, wherein the main ball seal further comprises at least one retractable diaphragm.

10. The ball valve device of claim 9, wherein the at least one retractable diaphragm comprises a material selected from the group consisting of silicon rubber, ethylene propylene diene monomer rubber, perfluoroelastomer, and combinations thereof.

11. The ball valve device of claim 9 further comprising at least one piston, wherein movement of the piston causes the main ball seal to move between the open position and the closed position.

12. The ball valve device of claim 11, wherein the piston is pneumatic.

13. The ball valve device of claim 12, wherein the piston is moveable by a force exerted by one mechanism selected from the group consisting of compressed gas and an actuator spring.

14. A method of cleaning a spindle cavity in a ball valve device, the method comprising:
providing a ball valve device, the ball valve device comprising
a. a body that defines a spindle cavity and an inner cavity, the inner cavity having a passageway through which a product can flow, wherein the body is configured for attachment to a pipeline;
b. a ball positioned within the inner cavity of the body, the ball having a central bore, wherein the ball is rotatable between a first position in which the central bore is in alignment with the passageway of the inner cavity such that flow of product through the bore is permitted and a second position in which the central bore is not aligned with the passageway of the inner cavity such that flow of product through the bore is obstructed;
c. a rotatable spindle positioned within the spindle cavity, the rotatable spindle being coupled with the ball such that rotation of the spindle causes a corresponding rotation of the ball;
d. at least one spindle seal positioned within the body, the at least one spindle seal being moveable between an open position and a closed position, wherein the spindle seal contacts the spindle when the spindle seal is in the closed position to obstruct the flow of product into or out of the spindle cavity;
e. at least one main ball seal positioned within the body, the at least one main ball seal being moveable between an open position and a closed position, wherein the main ball seal contacts a surface of the ball when the main ball seal is in the closed position to obstruct the flow of product into or out of the inner cavity; and
f. a drain extending from the body, the drain permitting the product to flow out of the ball valve device;
rotating the ball to the second position such that a flowable product is obstructed from flowing through the central bore;
opening the at least one main ball seal;
opening the at least one spindle seal;
providing a cleaning fluid to flow through the spindle cavity;
expelling the cleaning fluid through the drain.

15. The method of claim 14, wherein a compressed gas is used to open the at least one main ball seal.

16. The method of claim 14, wherein a compressed gas is used to open the at least one spindle seal.

17. The method of claim 14, wherein the method is automated.

18. A method of cleaning an inner cavity of a ball valve device, the method comprising:
providing a ball valve device, the ball valve comprising
a. a body that defines a spindle cavity and an inner cavity, the inner cavity having a passageway through which a product can flow, the body being configurable to be connected to a pipeline;
b. a ball positioned within the inner cavity of the body, the ball having a central bore, and wherein the ball is rotatable between a first position in which the central bore is in alignment with the passageway of the inner cavity permitting the flow of product through the bore and a second position in which the central bore is not aligned with the passageway of the inner cavity obstructing the flow of product through the bore;
c. a rotatable spindle positioned within the spindle cavity, the rotatable spindle being coupled with the ball such that rotation of the spindle causes a corresponding rotation of the ball;
d. at least one spindle seal positioned within the body, the at least one spindle seal being moveable between an open position and a closed position, wherein the spindle seal contacts the spindle when the spindle seal is in the closed position to obstruct the flow of product into or out of the spindle cavity;
e. at least one main ball seal positioned within the body, the at least one main ball seal being moveable between an open position and a closed position, wherein the main ball seal contacts a surface of the ball when the main ball seal is in the closed position to obstruct the flow of product into or out of the inner cavity; and
f. a drain extending from the body, the drain permitting the product to flow out of the ball valve device;
rotating the ball to the second position such that a flowable product is obstructed from flowing through the central bore;
closing the at least one spindle seal;
providing a cleaning fluid to flow through the spindle cavity;
closing the at least one main ball seal;
expelling the cleaning fluid through the drain.

19. The method of claim 18, wherein a compressed gas is used to close the at least one main ball seal and the at least one spindle seal.

20. The method of claim 18, wherein the method is automated.
